(19) United States
(12) Patent Application Publication
(10) Pub. No.: US 2026/0030007 A1
(43) Pub. Date: Jan. 29, 2026

(54) METHOD AND SYSTEM FOR IMPLEMENTING ORCHESTRATION OF CONTINUOUS INTEGRATION AND CONTINUOUS DEPLOYMENT

(71) Applicant: JPMorgan Chase Bank, N.A., New York, NY (US)

(72) Inventors: Purvesh SHAH, Mumbai (IN); Animesh KOTWAL, Panvel (IN); Madhuri SHARMA, Mumbai (IN); Akshay THAKKAR, Mumbai (IN)

(73) Assignee: JPMorgan Chase Bank, N.A., New York, NY (US)

(21) Appl. No.: 18/883,714

(22) Filed: Sep. 12, 2024

(30) Foreign Application Priority Data
Jul. 26, 2024 (IN) 202411056953

(51) Int. Cl. G06F 8/60; G06F 8/71

(52) U.S. Cl. CPC G06F 8/60; G06F 8/71

(57) ABSTRACT

A system and method for implementing an orchestration of continuous integration and continuous deployment (CI-CD) are disclosed. The method includes receiving a set of data from at least one user to allow access to a developer utility platform and a request to access project data associated with at least one software product. The method includes fetching the project data from at least one database and displaying a plurality of options related to the project data. The method includes creating at least one pull request upon receiving input that relates to the plurality of options. The method includes generating the at least one pull request in case of an absence of a reception of a code freeze request. Next, the method includes implementing a deployment of a change in a code into a target branch from a source branch based on the generated at least one pull request.

### CROSS-REFERENCE TO RELATED APPLICATIONS

This application claims priority benefit from Indian Application No. 202411056953, filed on Jul. 26, 2024 in the India Patent Office, which is hereby incorporated by reference in its entirety.

### FIELD OF THE DISCLOSURE

This technology generally relates to a software development and operations (DevOps) for a software delivery, and more particularly relates to methods and systems for implementing an orchestration of continuous integration and continuous deployment (CI-CD) activities.

### BACKGROUND INFORMATION

The following description of the related art is intended to provide background information pertaining to the field of the disclosure. This section may include certain aspects of the art that may be related to various features of the present disclosure. However, it should be appreciated that this section is used only to enhance the understanding of the reader with respect to the present disclosure, and not as admissions of the prior art.

With advancements in technology, various business sectors are accelerating their operations through the utilization of various tools and software. Nowadays, a popular methodology used for the creation and deployment of such software is known as the software development life cycle (SDLC). The SDLC encompasses phases such as research, analysis, design, implementation, and maintenance of a software asset. Additionally, to ensure faster and continuous delivery of software assets, the SDLC for DevOps integrates the concepts and procedures of both software development and operations. DevOps may be employed to shorten the development lifecycle of systems and enhance the capability for continuous software delivery.

In the field of software development, the continuous integration and continuous deployment (CI-CD) pipeline has gained popularity as a methodology. However, developers often face challenges in effectively utilizing CI-CD pipeline tools due to a lack of automation in various activities, such as defining branching strategy, cleaning up older feature branches, and generating pull requests for single or multiple branches in the CI-CD process.

Due to the lack of automation of the CI-CD processes, developers encounter various problems. For instance, developers may struggle to configure branching strategies in the existing tools which results in various problems such as merging pull requests directly from the development branch to production without passing through testing regions. Additionally, developers often need to manually clean up older feature branches generated during the software asset's development. This manual cleanup process is time-consuming and resource-intensive. Furthermore, developers face challenges in creating pull requests for each code change or branch merge manually. These efforts in the generation of multiple pull requests significantly impact developers' overall productivity. Improper implementation of continuous integration and deployment during software development impacts the responsiveness and overall scalability of the software asset.

Hence, in view of these and other existing limitations, there arises an imperative need to provide an efficient solution to overcome the above-mentioned limitations and to provide a method and system that may implement the orchestration of continuous integration and continuous deployment (CI-CD) activities.

### SUMMARY

The present disclosure, through one or more of its various aspects, embodiments, and/or specific features or sub-components, provides, inter alias, various systems, servers, devices, methods, media, programs, and platforms for implementing an orchestration of continuous integration and continuous deployment (CI-CD).

According to an aspect of the present disclosure, a method for implementing the orchestration of continuous integration and continuous deployment (CI-CD) is disclosed. The method is implemented by at least one processor. The method includes receiving, by the at least one processor, a set of data from at least one user, via a user interface (UI), to allow access to a developer utility platform. Next, the method includes receiving, by the at least one processor, a request from the at least one user to access project data associated with at least one software product. Next, the method includes fetching, by the at least one processor, the project data from at least one database, in response to the request received from the at least one user. Next, the method includes displaying, by the at least one processor, a plurality of options related to the project data, to the at least one user. Next, the method includes creating, by the at least one processor, at least one pull request upon receiving an input that relates to the plurality of options from the at least one user. Next, the method includes generating, by the at least one processor, the at least one pull request in case of an absence of a reception of a code freeze request. Next, the method includes implementing, by the at least one processor, a deployment of a change in a code into a target branch from a source branch based on the generated at least one pull request.

In accordance with an exemplary embodiment, the plurality of options may include a selection of at least one from among a team, a repository, the source branch, the target branch, an employee identity (ID) of a reviewer, a request to view the at least one pull request, a request to delete the at least one pull request, a request to clean at least one outdated branch, the code freeze requested input, and a deployment freeze request.

In accordance with an exemplary embodiment, the input of the at least one user may be received as one from among a text-based input and a command-based input, wherein the input is received in a sequential manner.

In accordance with an exemplary embodiment, the project data may include a project name, a project date, a number of users working on the project, and information related to teams working on the project.

In accordance with an exemplary embodiment, the request to delete the at least one pull request may correspond to a removal of at least one from among outdated pull requests and unwanted pull requests.

In accordance with an exemplary embodiment, the set of data may include login credentials and registration details that are usable for accessing the developer utility platform.

In accordance with an exemplary embodiment, the deployment of the change in the code may correspond to a merging of the code from the source branch to the target branch.

In accordance with an exemplary embodiment, the method further includes displaying, by the at least one processor to the at least one user, a pull request uniform resource locator (URL) for the generated at least one pull request.

According to another aspect of the present disclosure, a computing device configured to implement an execution of a method for implementing an orchestration of continuous integration and continuous deployment (CI-CD) is disclosed. The computing device includes a processor; a memory; and a communication interface coupled to each of the processor and the memory. The processor may be configured to receive a set of data from at least one user via a user interface (UI) to allow access to a developer utility platform. Next, the processor may be configured to receive a request from the at least one user to access project data associated with at least one software product. Next, the processor may be configured to fetch the project data from at least one database, in response to the request received from the at least one user. Next, the processor may be configured to display a plurality of options related to the project data, to the at least one user. Next, the processor may be configured to create at least one pull request upon reception of an input that relates to the plurality of options from the at least one user. Next, the processor may be configured to generate the at least one pull request in case of an absence of a reception of a code freeze request. Next, the processor may be configured to implement a deployment of a change in a code into a target branch from a source branch based on the generated at least one pull request.

In accordance with an exemplary embodiment, the plurality of options may include a selection of at least one from among a team, a repository, the source branch, the target branch, an employee identity (ID) of a reviewer, a request to view the at least one pull request, a request to delete the at least one pull request, a request to clean at least one outdated branch, the code freeze request, and a deployment freeze request.

In accordance with an exemplary embodiment, the input received from the at least one user may be received as one from among a text-based input and a command-based input, wherein the input is received in a sequential manner.

In accordance with an exemplary embodiment, the project data may include a project name, a project date, a number of users working on a project, and information related to teams working on the project.

In accordance with an exemplary embodiment, the request to delete the at least one pull request may correspond to a removal of at least one from among outdated pull requests and unwanted pull requests.

In accordance with an exemplary embodiment, the set of data may include login credentials and registration details that are usable for accessing the developer utility platform.

In accordance with an exemplary embodiment, the deployment of the change in the code may correspond to a merging of the code from the source branch to the target branch.

In accordance with an exemplary embodiment, the processor may be further configured to display, to the at least one user, a pull request uniform resource locator (URL) for the generated at least one pull request.

According to yet another aspect of the present disclosure, a non-transitory computer-readable storage medium storing instructions for implementing an orchestration of continuous integration and continuous deployment (CI-CD) is disclosed. The instructions include executable code which, when executed by a processor, may cause the processor to receive a set of data from at least one user, via a user interface (UI), to allow access to a developer utility platform; receive a request from the at least one user to access project data associated with at least one software product; fetch the project data from at least one database, in response to the request received from the at least one user; display a plurality of options related to the project data, to the at least one user; create at least one pull request upon reception of an input that relates to the plurality of options from the at least one user; generate the at least one pull request in case of an absence of a reception of a code freeze request; and implement a deployment of a change in a code into a target branch from a source branch based on the generated at least one pull request.

In accordance with an exemplary embodiment, the plurality of options may include a selection of at least one from among a team, a repository, the source branch, the target branch, an employee identity (ID) of a reviewer, a request to view the at least one pull request, a request to delete the at least one pull request, a request to clean at least one outdated branch, the code freeze request, and a deployment freeze request.

In accordance with an exemplary embodiment, the input of the at least one user may be received as one from among a text-based input and a command-based input, wherein the input is received in a sequential manner.

In accordance with an exemplary embodiment, the project data may include a project name, a project date, a number of users working on a project, and information related to teams working on the project.

In accordance with an exemplary embodiment, the request to delete the at least one pull request may correspond to a removal of at least one from among outdated pull requests and unwanted pull requests.

In accordance with an exemplary embodiment, the set of data may include login credentials and registration details that are usable for accessing the developer utility platform.

In accordance with an exemplary embodiment, the deployment of the change in the code may correspond to a merging of the code from the source branch to the target branch.

In accordance with an exemplary embodiment, the executable code, when executed, may further cause the processor to display, to the at least one user, a pull request uniform resource locator (URL) for the generated at least one pull request.

### BRIEF DESCRIPTION OF THE DRAWINGS

The present disclosure is further described in the detailed description which follows, in reference to the noted plurality of drawings, by way of non-limiting examples of exemplary embodiments of the present disclosure, in which like characters represent like elements throughout the several views of the drawings.

FIG. 1 illustrates an exemplary computer system for implementing an orchestration of continuous integration and continuous deployment, in accordance with an exemplary embodiment of the present disclosure.

FIG. 2 illustrates an exemplary diagram of a network environment for implementing an orchestration of continuous integration and continuous deployment, in accordance with an exemplary embodiment of the present disclosure.

FIG. 3 illustrates a system diagram for implementing an orchestration of continuous integration and continuous deployment, in accordance with an exemplary embodiment of the present disclosure.

FIG. 4 illustrates an exemplary method flow diagram for implementing an orchestration of continuous integration and continuous deployment, in accordance with an exemplary embodiment of the present disclosure.

FIG. 5 illustrates a process flow diagram usable for implementing an orchestration of continuous integration and continuous deployment, in accordance with an exemplary embodiment of the present disclosure.

### DETAILED DESCRIPTION

Exemplary embodiments now will be described with reference to the accompanying drawings. The invention may, however, be embodied in many different forms and should not be construed as limited to the embodiments set forth herein; rather, these embodiments are provided so that this invention will be thorough and complete, and will fully convey its scope to those skilled in the art. The terminology used in the detailed description of the particular exemplary embodiments illustrated in the accompanying drawings is not intended to be limiting. In the drawings, like numbers refer to like elements.

The specification may refer to “an”, “one” or “some” embodiment(s) in several locations. This does not necessarily imply that each such reference is to the same embodiment(s), or that the feature only applies to a single embodiment. Single features of different embodiments may also be combined to provide other embodiments.

As used herein, the singular forms “a”, “an” and “the” are intended to include the plural forms as well, unless expressly stated otherwise. It will be further understood that the terms “include”, “comprises”, “including” and/or “comprising” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations and arrangements of one or more of the associated listed items. Also, as used herein, the phrase “at least one” means and includes “one or more” and such phrases or terms can be used interchangeably.

Unless otherwise defined, all terms (including technical and scientific terms) used herein have the same meaning as commonly understood by one of ordinary skill in the art to which this invention pertains. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The figures depict a simplified structure only showing some elements and functional entities, all being logical units whose implementation may differ from what is shown. The connections shown are logical connections and the actual physical connections may be different.

In addition, all logical units and/or controllers described and depicted in the figures include the software and/or hardware components required for the unit to function. Furthermore, each unit may comprise within itself one or more components, which are implicitly understood. These components may be operatively coupled to each other and be configured to communicate with each other to perform the function of the said unit.

In the following description, for the purposes of explanation, numerous specific details have been set forth in order to provide a description of the disclosure. It will be apparent, however, that the invention may be practiced without these specific details and features.

Through one or more of its various aspects, embodiments and/or specific features or sub-components of the present disclosure, are intended to bring out one or more of the advantages as specifically described above and noted below.

The examples may also be embodied as one or more non-transitory computer-readable medium having instructions stored thereon for one or more aspects of the present technology as described and illustrated by way of the examples herein. The instructions in some examples include executable code that, when executed by one or more processors, causes the processors to carry out steps necessary to implement the methods of the examples of this technology that are described and illustrated herein.

To overcome the above-mentioned problems, the present disclosure provides a method and system for implementing an orchestration of continuous integration and continuous deployment (CI-CD). More particularly, to overcome the problems associated with an inefficient and complex CI-CD process, such as the cleanup of older feature branches, deletion of pull requests during software development, and a deployment freeze request, the present disclosure provides a solution that implements the orchestration of CI-CD with minimal manual assistance from developers. In the present disclosure, the system first receives a set of data from a user to allow access to a developer utility platform. The system further receives a request from the user to access project data associated with a software product from a database. The system further fetches the project data from the database and displays a plurality of options to the user to receive user input on the displayed plurality of options. Next, the system creates at least one pull request upon reception of the user input on the plurality of options and generates the at least one pull request in case of an absence of a code freeze request raised by the user. The system further implements a deployment of a change in a code into a target branch from a source branch based on the generated at least one pull request. The deployment of the change in the code corresponds to the merging of the code from the source branch to the target branch. This way the system allows the user to create multiple pull requests and effectively implement the orchestration for tasks related to continuous integration and continuous deployment.

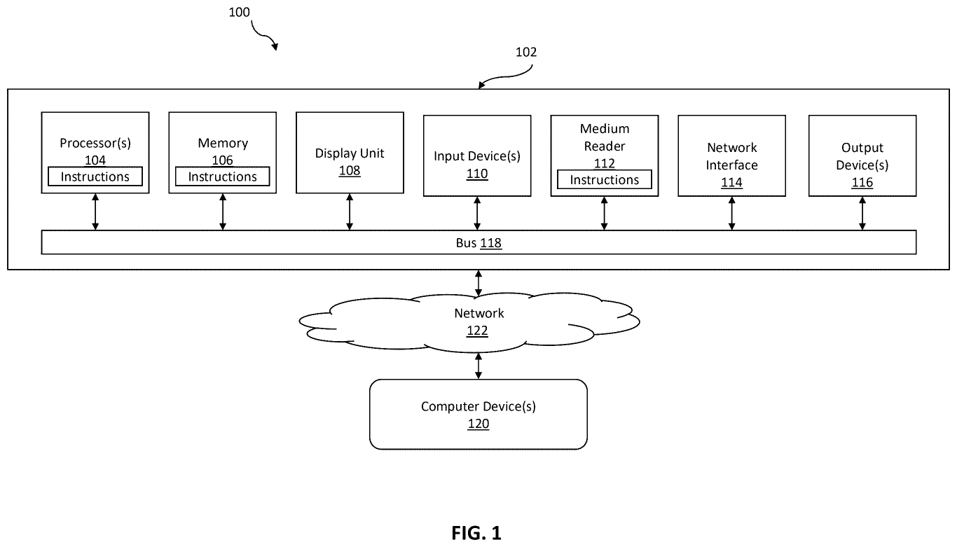

FIG. 1 is an exemplary system for use in accordance with the embodiments described herein. The system 100 is generally shown and may include a computer system 102 which is generally indicated. The term “computer system” may also be referred to as “computing device” and such phrases/terms can be used interchangeably in the specifications.

The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud-based environments. Even further, the instructions may be operative in such cloud-based computing environment.

In a networked deployment, the computer system 102 may operate in the capacity of a server or as a client-user computer in a server-client user network environment, a client-user computer in a cloud-based computing environment, or as a peer computer system in a peer-to-peer (or distributed) network environment. The computer system 102, or portions thereof, may be implemented as, or incorporated into, various devices, such as a personal computer, a virtual desktop computer, a tablet computer, a set-top box, a personal digital assistant, a mobile device, a palmtop computer, a laptop computer, a desktop computer, a communications device, a wireless smartphone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application-specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in or coupled to, a single device or multiple devices.

The computer system 102 may also include a computer memory 106. The computer memory 106 may include a static memory, a dynamic memory, or both in communication. Memories described herein are tangible storage mediums that can store data and executable instructions and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories, as described herein, may be random access memory (RAM), read-only memory (ROM), flash memory, electrically programmable read-only memory (EPROM), electrically erasable programmable read-only memory (EEPROM), registers, a hard disk, a cache, a removable disk, tape, compact disk read-only memory (CD-ROM), digital versatile disk (DVD), floppy disk, Blu-ray disk, or any other form of storage medium known in the art. Memories may be volatile or non-volatile, secure and/or encrypted, unsecure and/or unencrypted. As regards the present disclosure, the computer memory 106 may comprise any combination of memories or a single storage.

The computer system 102 may further include a display unit 108, such as a liquid crystal display (LCD), an organic light emitting diode (OLED), a flat panel display, a solid-state display, a cathode ray tube (CRT), a plasma display, or any other type of display, examples of which are well known to skilled persons.

The computer system 102 may also include at least one input device 110, such as a keyboard, a touch-sensitive input screen or pad, a speech input, a mouse, a remote-control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g., software, from any of the memories described herein. The instructions, when executed by a processor 104, can be used to perform one or more of the methods and processes as described herein. In a particular embodiment, the instructions may reside completely, or at least partially, within the memory 106, the medium reader 112, and/or the processor 104 during execution by the computer system 102.

Furthermore, the computer system 102 may include any additional devices, components, parts, peripherals, hardware, software, or any combination thereof which are commonly known and understood as being included with or within a computer system, such as but not limited to, a network interface 114 and an output device 116. The output device 116 may include but is not limited to, a speaker, an audio out, a video out, a remote-controlled output, a printer, or any combination thereof. Additionally, the term “Network interface” may also be referred to as “Communication interface” and such phrases/terms can be used interchangeably in the specification.

Each of the components of the computer system 102 may be interconnected and communicate via a bus 118 or other communication link. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect expresses, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, Bluetooth, Zigbee, infrared, near-field communication, ultra-band, or any combination thereof. Those skilled in the art appreciate that additional networks 122 which are known and understood may additionally or alternatively be used and that the exemplary networks 122 are not limiting or exhaustive. Also, while the network 122 is shown in FIG. 1 as a wireless network, those skilled in the art appreciate that the network 122 may also be a wired network.

The additional computer device 120 is shown in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing can be constructed to implement one or more of the methods or functionalities as described herein, and a processor 104 described herein may be used to support a virtual processing environment.

As described herein, various embodiments provide methods and systems for implementing an orchestration of continuous integration and continuous deployment (CI-CD).

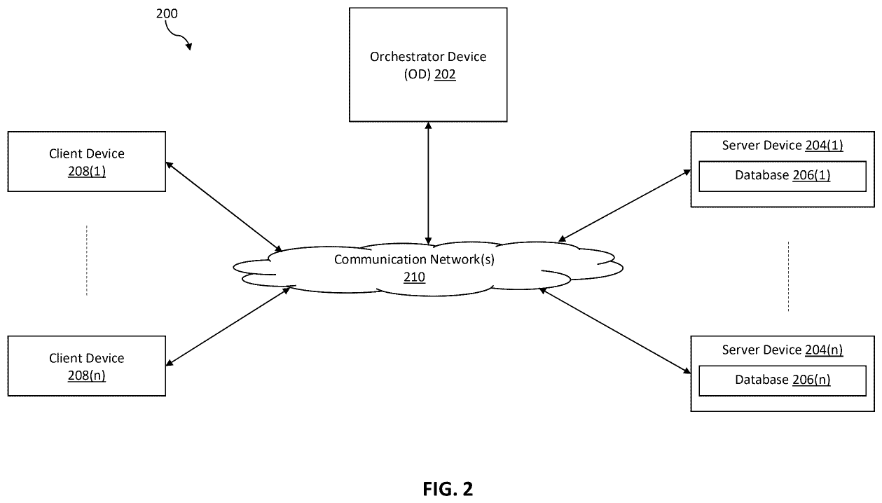

Referring to FIG. 2, a schematic of an exemplary network environment 200 for implementing an orchestration of continuous integration and continuous deployment (CI-CD) is illustrated. In an exemplary implementation, the method is executable on any networked computer platform, such as, for example, a personal computer (PC).

The method for implementing the orchestration of continuous integration and continuous deployment (CI-CD) may be executed by an orchestrator device (OD) 202. The OD 202 may be the same or similar to the computer system 102 as described with respect to FIG. 1. The OD 202 may store one or more applications that may include executable instructions that, when executed by the OD 202, cause the OD 202 to perform desired actions, such as to transmit, receive, or otherwise process network messages, for example, and to perform other actions described and illustrated below with reference to the figures. The application(s) may be implemented as modules or components of other applications. Further, the application(s) may be implemented as operating system extensions, modules, plugins, or the like.

In a non-limiting example, the application(s) may be operative in a cloud-based computing environment. The application(s) may be executed within or as a virtual machine(s) or virtual server(s) that may be managed in a cloud-based computing environment. Also, the application(s), and even the OD 202 itself, may be located in the virtual server(s) running in a cloud-based computing environment rather than being tied to one or more specific physical network computing devices. Also, the application(s) may be running in one or more virtual machines (VMs) executing on the OD 202. Additionally, in one or more embodiments of this technology, virtual machine(s) running on the OD 202 may be managed or supervised by a hypervisor.

In the network environment 200 of FIG. 2, the OD 202 is coupled to a plurality of server devices 204(1)-204(n) that hosts a plurality of databases 206(1)-206(n), and also to a plurality of client devices 208(1)-208(n) via communication network(s) 210. A communication interface of the OD 202, such as the network interface 114 of the computer system 102 of FIG. 1, operatively couples and communicates between the OD 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the OD 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein. This technology provides several advantages including methods, non-transitory computer-readable media, and ODs that efficiently implement the method for the orchestration of continuous integration and continuous deployment (CI-CD).

By way of example only, the communication network(s) 210 may include local area network(s) (LAN(s)) or wide area network(s) (WAN(s)) and can use transmission control protocol/internet protocol (TCP/IP) over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), public switched telephone networks (PSTNs), ethernet-based packet data networks (PDNs), combinations thereof, and the like.

The OD 202 may be a standalone device or integrated with one or more other devices or apparatuses, such as one or more of the server devices 204(1)-204(n), for example. In one particular example, the OD 202 may include or be hosted by one of the server devices 204(1)-204(n), and other arrangements are also possible. Moreover, one or more of the devices of the OD 202 may be in a same or a different communication network including one or more public, private, or cloud-based networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. In an example, the server devices 204(1)-204(n) may process requests received from the OD 202 via the communication network(s) 210 according to the hypertext transfer protocol (HTTP)-based and/or javascript object notation (JSON) protocol, for example, although other protocols may also be used.

The server devices 204(1)-204(n) may be hardware or software or may represent a system with multiple servers in a pool, which may include internal or external networks. The server devices 204(1)-204(n) hosts the databases or repositories 206(1)-206(n) that are configured to store data associated with the developer utility platform.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a controller/agent approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to-peer architecture, virtual machines, or within a cloud-based architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. For example, the client devices 208(1)-208(n) in this example may include any type of computing device that can interact with the OD 202 via communication network(s) 210. Accordingly, the client devices 208(1)-208(n) may be mobile computing devices, desktop computing devices, laptop computing devices, tablet computing devices, or the like, that host chat, e-mail, or voice-to-text applications, for example. In an exemplary implementation, at one client device 208 is a wireless mobile communication device, e.g., a smartphone.

The client devices 208(1)-208(n) may run interface applications, such as standard web browsers or standalone client applications, which may provide an interface to communicate with the OD 202 via the communication network(s) 210 in order to communicate user requests and information. The client devices 208(1)-208(n) may further include, among other features, a display device, such as a display unit or touchscreen, and/or an input device, such as a keyboard, for example.

Although the exemplary network environment 200 with the OD 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the OD 202, the server devices 204(1)-204(n), or the client devices 208(1)-208(n), for example, may be configured to operate as virtual instances on the same physical machine. In other words, one or more of the OD 202, the server devices 204(1)-204(n), or the client devices 208(1)-208(n) may operate on the same physical device rather than as separate devices communicating through communication network(s) 210. Additionally, there may be more or fewer ODs 202, server devices 204(1)-204(n), or client devices 208(1)-208(n) than illustrated in FIG. 2.

In addition, two or more computing systems or devices may be substituted for any one of the systems or devices in any example. Accordingly, principles and advantages of distributed processing, such as redundancy and replication, may also be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, packet data networks (PDNs), the Internet, intranets, and combinations thereof.

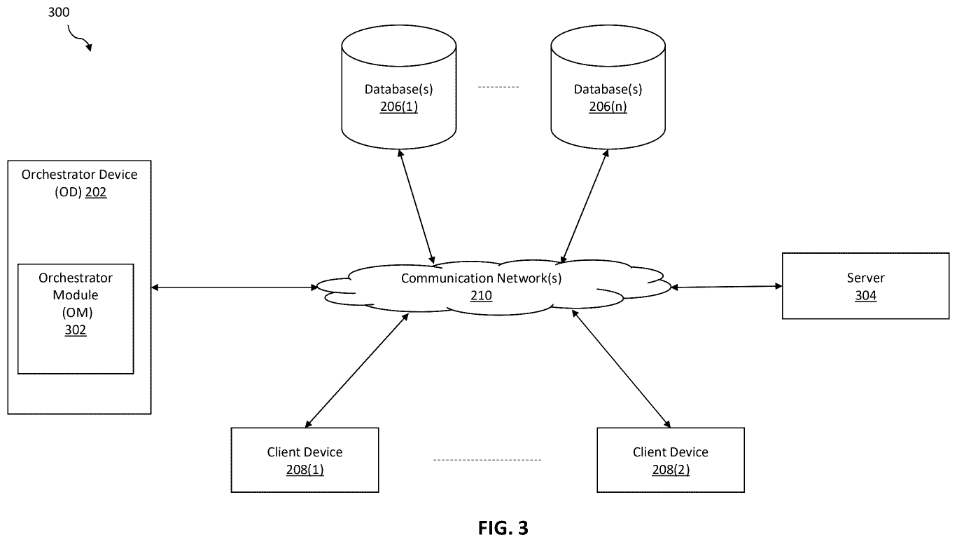

FIG. 3 illustrates a system diagram for implementing an orchestration of continuous integration and continuous deployment (CI-CD), in accordance with an exemplary embodiment.

As illustrated in FIG. 3, the system 300 may include orchestrator device (OD) 202 within which an orchestrator module (OM) 302 is embedded, a server 304, a database(s) 206(1) . . . 206(n), a plurality of client devices 208(1) . . . 208(2), and a communication network(s) 210.

According to exemplary embodiments, the system 300 may comprise the orchestrator device (OD) 202 including the OM 302 may be connected to the server 304 and the database(s) 206(1) . . . 206(n) via the communication network(s) 210, but the disclosure is not limited thereto. The OD 202 may also be connected to the plurality of client devices 208(1) . . . 208(2) via the communication network(s) 210, but the disclosure is not limited thereto. The database(s) 206(1) . . . 206(n) may include a rule database.

In an embodiment, the OD 202 is described and shown in FIG. 3 includes the OM 302, although it may include other rules, policies, modules, databases, or applications, for example. As will be described below, the OM 302 is configured to carry out a method for implementing the orchestration of continuous integration and continuous deployment (CI-CD).

An exemplary system 300 for enabling a mechanism for implementing an orchestration of continuous integration and continuous deployment (CI-CD) by utilizing the network environment of FIG. 2 is shown as being executed in FIG. 3. Specifically, a first client device 208(1) and a second client device 208(2) are illustrated as being in communication with OD 202. In this regard, the first client device 208(1) and the second client device 208(2) may be “clients” of the OD 202 and are described herein as such. Nevertheless, it is to be known and understood that the first client device 208(1) and/or the second client device 208(2) need not necessarily be “clients” of the OD 202, or any entity described in association therewith herein. Any additional or alternative relationship may exist between either or both of the first client device 208(1) and the second client device 208(2) and the OD 202, or no relationship may exist.

Further, the OD 202 is illustrated as being able to access one or more database(s) 206(1) 206(n). The OM 302 may be configured to access these repositories/databases to provide a method for implementing the orchestration of continuous integration and continuous deployment (CI-CD). In some embodiment, the server 304 may be the same or equivalent to the server device 204 as illustrated in FIG. 2

The first client device 208(1) may be, for example, a smartphone. The first client device 208(1) may be any additional device described herein. The second client device 208(2) may be, for example, a personal computer (PC). The second client device 208(2) may also be any additional device described herein.

The process may be executed via the communication network(s) 210, which may comprise plural networks as described above. For example, in an exemplary embodiment, either or both the first client device 208(1) and the second client device 208(2) may communicate with the OD 202 via broadband or cellular communication. These embodiments are merely exemplary and are not limiting or exhaustive.

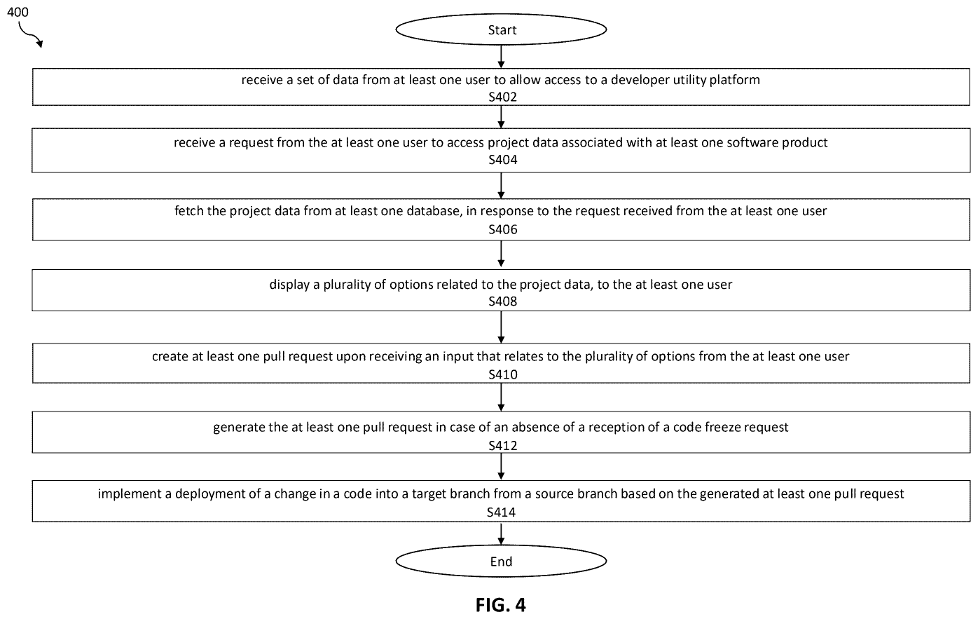

Referring to FIG. 4, an exemplary method 400 is shown for implementing an orchestration of continuous integration and continuous deployment (CI-CD), in accordance with an exemplary implementation. In particular, the exemplary method 400 is shown for implementing the orchestration of continuous integration and continuous deployment (CI-CD) for executing various types of manual tasks that need to be performed by a developer or a user in CI-CD activities.

As shown in FIG. 4, method 400 begins following a need for automating CI-CD activities. The user may wish to initiate implementing the orchestration process of continuous integration and continuous deployment (CI-CD) to automate manual tasks that need to be performed in the CI-CD activities. The method 400 is implemented by at least one processor 104.

At step S402, the method 400 includes receiving, by the at least one processor 104, a set of data from at least one user, via a user interface (UI), to allow access to a developer utility platform.

The term “user” as used herein corresponds to the user, an employee, and a team member working in one of the various departments of an organization who is responsible for the development of a software product.

The term “continuous integration” herein may correspond to a process of automatically and frequently incorporating code changes into a common source code repository.

The term “continuous deployment” herein corresponds to an approach in which software functionalities are delivered frequently and through automated deployments.

In an exemplary implementation, at first, registration of the at least one user is processed via the user interface (UI) of the developer utility platform via a user device. The at least one user needs to provide the registration details to get onboard and then login credentials to gain access to the developer utility platform. The method employed to receive the registration details may include direct user input through the UI where the at least one user fills out onboarding forms or answers questions to get registered on the developer utility platform.

The term “registration” herein may correspond to the process of allowing access to a platform (for example, the developer utility platform) to the at least one user that enables the at least one user to sign in to the platform in order to complete a specific service (e.g., generation of bulk pull requests and cleanup of feature branches, code deployment, and deployment freeze).

The registration details may include but are not limited to, a developer utility function identity (ID), a seal identity (ID), a project key, a code repository uniform resource locator (URL), a branching strategy, repository details, and a scrum team definition. The login credentials may include, but are not limited to, a user identity (ID), an email identity (ID) or a mobile number, a password, and a name of the at least one user.

In some examples, the user device may include one of a tablet, a smartphone, a laptop, a desktop computer, a mainframe computer, a phablet, a smartwatch, a personal digital assistant (PDA), and the like.

In an exemplary implementation, the UI is operated by the at least one user. The UI may be a graphical user interface (GUI). For example, the UI may be rendered on a display unit of the user device.

Next, the method may include authenticating the at least one user via an authentication application programming interface (API). The developer utility platform may be an application or a centralized online platform. In an exemplary implementation, the user may use the set of data such as login credentials and registration details to access the developer utility platform. The authentication API (e.g., a third-party API or an external API) may validate the authenticity of the user based on the at least one from among the login credentials, a biometric input, a facial recognition, and the like. In an example, when a user attempts to log in using the login credentials, the developer utility platform may send the provided credentials to the authentication API through secure communication channels, without storing data associated with the login credentials of the user. The authentication API then processes these credentials and verifies their authenticity against stored user data. In case the provided credentials are correct, the user is granted access to the developer utility platform, otherwise, the access is denied.

At step S404, the method includes receiving, by the at least one processor 104, a request from the at least one user to access project data associated with at least one software product.

In an exemplary implementation, the request is raised by the at least one user via the developer utility platform. The project data includes data associated with a project related to the at least one software product. The project data may include, but is not limited to, a project name, a project date, a number of users working on a project, and information related to teams working on the project.

At step S406, the method includes fetching, by the at least one processor 104, the project data from at least one database, in response to the request received from the at least one user.

In an exemplary implementation, the method includes fetching, by the at least one processor 104, the project data from at least one external source. The at least one external source may be selected from but is not limited to, a server, a cloud server, the at least one database, portable storage devices (e.g., external solid-state drive (SSD) and hard disk drive (HDD), network-attached storage solid state drive (SSD), or other memory storage means). The at least one database is connected with the developer utility platform via a network. The network may be an internet-based network.

In an exemplary implementation, the project data may be fetched using secure data communication protocols to ensure the integrity and confidentiality of the project data. It would be appreciated by the person skilled in the art that the aim here is to create a centralized platform (for example, the developer utility platform) for developers or users that allows the users to implement the orchestration of the CI-CD activities.

At step S408, the method includes displaying, by the at least one processor 104, a plurality of options related to the project data, to the at least one user.

In an exemplary implementation, the method includes rendering the plurality of options related to the project data via the UI of the developer utility platform for receiving a user input on the displayed plurality of options.

In an exemplary implementation, the plurality of options is displayed (for example, displayed as a drop-down menu or list) in a sequential manner.

The plurality of options may include the selection of at least one from among a team, a repository, a source branch, a target branch, an employee ID of a reviewer, a request to view at least one pull request, a request to delete the at least one pull request, a request to clean at least one outdated branch, the code freeze request, and a deployment freeze request.

In an exemplary implementation, if a user wants to view information related to teams working on the project corresponding to the project data, then the user is required to select an option such as “teams” via the UI. Upon selection of the option “teams”, the at least one processor 104 causes the UI to display the information of teams working on the project. Thereafter, the at least one processor 104 is configured to receive an input (for example, selection of the at least one team from a plurality of teams via the UI or selection of desired team) from the user in response to the option displayed to the user for the selection of teams.

In another exemplary implementation, if a user is looking for any desired repository, then the user is required to select an option such as “repository” via the UI. Upon selection of the option “repository” by the user, the at least one processor 104 causes the UI to display repositories belonging to the project. Thereafter, the at least one processor 104 is configured to receive the input (for example, selection of the at least one repository via the UI or selection of desired repository) of the user in response to the displayed repositories.

In another exemplary implementation, if the user is looking for any source branch for merging a code, then the user is required to select an option such as “source branch” via the UI. Upon selection of the option “source branch” by the user, the at least one processor 104 causes the UI to display a list of branches (or prepopulated dropdown values) to the user that belongs to the project.

In another exemplary implementation, if the user is looking for a target branch for merging the code, then the user is required to select an option such as “target branch” via the UI. Upon selection of the option “target branch” by the user, the at least one processor 104 causes the UI to display the list of branches belonging to the project. Accordingly, the user may choose one branch as the target branch from the list of branches.

In another exemplary implementation, if the user wants to provide the name of preferred reviewers to review the options selected by the user, then the user is required to select an option such as “employee identity (ID) of the reviewer” via the UI and then the user may provide the employee ID of at least one reviewer preferred by the user. The task of the reviewer is to review the code that needs to be promoted from the source branch to the target branch. Thus, the at least processor 104 may then pass the selected input related to “employee id of the reviewer” to the source code repository application programming interface (API) upon receiving the pull request creation from the user for further review of the code.

At step S410, the method includes creating, by the at least one processor 104, at least one pull request upon receiving an input that relates to the plurality of options from the at least one user.

The input received from the at least one user may be one of a text-based input or a command-based input, wherein the input that relates to the plurality of displayed options may be received in a sequential manner.

The method further includes allowing the at least one user to select the plurality of options via the UI to receive the required information for the creation and generation of the at least one pull request.

At step S412, the method includes generating, by the at least one processor 104, the at least one pull request in case of an absence of a reception of a code freeze request. The at least one pull request is generated only when no code freeze request is received for a selected branch. Thus, the method includes determining, by the at least one processor 104, the presence (existence) or the absence of the code freeze request raised by the at least one user.

For example, if the code freeze request is not received from the at least one user then the at least one processor 104 marks it as the absence of the code freeze request. If the code freeze request is received from the at least one user, then the at least one processor marks it as the presence of the code freeze request. In case of the absence of a reception of the code freeze request, the at least one processor 104 generates the at least one pull request. This way the present disclosure allows the generation of bulk pull requests for single or multiple branches.

In an exemplary implementation, the code freeze request may be generated by other team members of the at least one user to freeze the code. For example, a person or another user having access to the developer utility platform may request for activation of a code freeze window for the code freeze. If the code freeze window is defined or active, then no other user will be able to promote their code from the source branch to the target branch via the developer utility platform or directly via the source code repository until the expiry of the code freeze window or code freeze period.

The method includes displaying, by the at least one processor 104 to the at least one user, a pull request uniform resource locator (URL) for the generated at least one pull request in an event no request is received for the code freeze.

Further, the method includes generating, by the at least one processor 104, a failure message (also referred to as an error message) in case of detection of the existence of the code freeze request. In an exemplary implementation, the at least one processor 104 may display the failure message, in the form of the error message, via the UI of the developer utility platform. For example, an error banner (or region) on the screen of the application may display the failure message to the user.

At step S414, the method includes implementing, by the at least one processor 104, a deployment of a change in a code into the target branch from the source branch based on the generated at least one pull request. The deployment of the change in the code corresponds to the merging of the code from the source branch to the target branch.

In an exemplary implementation, a user (e.g., project manager, product owner, operation team head) may initiate a deployment freeze request to freeze the deployment of the code for a predefined period. During the deployment freeze phase or period, the at least one user may merge the code from the source branch to the target branch but may not be able to deploy the code to the given environment (e.g., production environment). During the deployment freeze phase, triggering of automated or manual deployment of the code via the development utilities (DEV Utils) is temporarily disabled, thereby restricting the at least one user from deploying the code in the given environment. However, the deployment of the change in the code may be implemented using the code deployment Application Programming Interface (API), if required. For example, the code deployment API may trigger the manual deployment of the change of code upon receiving the data associated with branches, teams, repositories, a token (also referred to as an authentication key), and the like.

The method further includes allowing the at least one user to request to view the at least one pull request (or view a list of created or existing pull requests). If the at least one user clicks on the option displayed as “the request to view the at least one pull request” via the UI to provide their input, then the at least one processor 104 causes the UI to display the generated at least one pull request or the list of created pull requests for the corresponding project.

The input of the at least one user may include, but is not limited to, selection of the at least one pull request or a selection of multiple pull requests (from the list of created or existing pull requests).

For example, if the at least one user selects an option such as “the request to delete the at least one pull request” via the UI, then the at least one processor 104 causes deletion of the generated at least one pull request or multiple pull requests (from the list of created pull requests) based on the user selection.

The request to delete the at least one pull request corresponds to a removal of at least one from among outdated pull requests and unwanted pull requests. This way the method allows the at least one user to delete the at least one pull request or multiple pull requests.

In an exemplary implementation, the method includes allowing at least one user to clean at least one outdated branch (for example, cleanup of outdated or older feature branches). For example, if the at least one user clicks on the option displayed as “the request to clean at least one outdated branch” via the UI to provide their input, then the at least one processor 104 causes the UI to display a list of outdated branches.

In an exemplary implementation, the method includes deleting, by the at least one processor 104, the at least one outdated branch (or outdated branches) selected by the at least one user. In another implementation, the method includes deleting, by the at least one processor 104, outdated branches crossing a threshold time period. The threshold time period may be selected from but not limited to, days, weeks, months, a quarter, and a year.

In an exemplary implementation, the threshold time period is sixty days. The method includes deleting, by the at least one processor 104, the outdated branches that are older than sixty days.

In an exemplary implementation, the at least one outdated branch may be deleted based on user input or automatically after crossing the threshold time period.

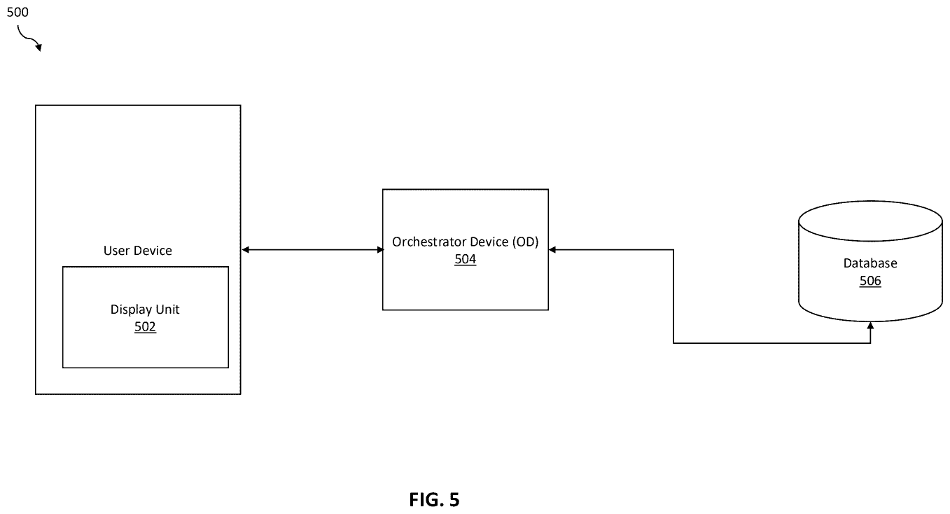

FIG. 5 illustrates a process flow diagram that represents a method for implementing an orchestration of continuous integration and continuous deployment (CI-CD), in accordance with an exemplary embodiment. As illustrated in FIG. 5, the process flow 500 begins with receiving, by an orchestrator device (OD) 504, a set of data from at least one user to allow access to a developer utility platform. In an exemplary implementation, the OD 504 receives a request from the at least one user to access a project data associated with at least one software product.

In an exemplary implementation, a user interface (UI) of the developer utility platform installed in a user device is operated by the at least one user to provide the set of data. The UI may be a graphical user interface (GUI). For example, the UI may be rendered on a display unit 502 of the user's device.

In some examples, the user device may include one of a tablet, a smartphone, a laptop, a desktop computer, a mainframe computer, a phablet, a smart watch, a personal digital assistant (PDA), and the like.

In an exemplary implementation, the OD 504 fetches the project data from at least one database 506 in response to the request received from the at least one user.

In an exemplary implementation, the OD 504 causes to display a plurality of options related to the project data via the UI, to the at least one user. Further, the OD 504 is configured to create at least one pull request upon reception of input from the at least one user on the plurality of options. The OD 504 is configured to generate the at least one pull request in case of an absence of a reception of a code freeze request, and finally implement a deployment of a change in a code into a target branch from a source branch based on the generated at least one pull request.

This way the OD 504 implements the orchestration of continuous integration and continuous deployment (CI-CD). Further, the OD 504 transmits a notification to the at least one user upon successful implementation of the deployment of the change in the code.

In an exemplary implementation, the OD 504 is configured to implement the deployment of the change in the code using a code deployment application programming interface (API).

It would be appreciated by the person skilled in the art that the OD 504 offers a full-circle, adaptable, and intelligent solution for implementing a method for implementing the orchestration of continuous integration and continuous deployment.

The present disclosure provides numerous advantages as given below. The present disclosure allows developers or users to generate bulk pull requests for single or multiple branches. The present disclosure allows the developers or users to lock or freeze a code for single or multiple branches. The present disclosure provides a solution to automate tasks (such as feature branch clean-up and generation of bulk pull requests) that need to be manually performed by the developers in the continuous integration and continuous deployment (CI-CD).

Although the invention has been described with reference to several exemplary embodiments, it is understood that the words that have been used are words of description and illustration, rather than words of limitation. Changes may be made within the purview of the appended claims, as presently stated, and as amended, without departing from the scope and spirit of the present disclosure in its aspects. Although the invention has been described with reference to particular means, materials, and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The terms “computer-readable medium” and “computer-readable storage medium” shall also include any medium that is capable of storing, encoding, or carrying a set of instructions for execution by a processor 104 or that causes a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tape, or other storage device to capture carrier wave signals such as a signal communicated via a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application-specific integrated circuits, programmable logic arrays, and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

According to an aspect of the present disclosure, a non-transitory computer-readable storage medium storing instructions for implementing an orchestration of continuous integration and continuous deployment (CI-CD) is disclosed. The instructions include executable code which, when executed by a processor 104, may cause the processor 104 to receive, via a communication interface, a set of data from at least one user to allow access to a developer utility platform; receive a request from the at least one user to access a project data associated with at least one software product; fetch the project data from at least one database, in response to the request received from the at least one user; display a plurality of options related to the project data, to the at least one user; create at least one pull request upon reception of input of the at least one user on the plurality of options; generate the at least one pull request in case of an absence of reception of a code freeze request; and implement a deployment of change in a code into a target branch from a source branch based on the generated at least one pull request.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually, and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, the inventive subject matter may be directed to less than all of the features of any of the disclosed embodiments. Thus, the following claims are incorporated into the Detailed Description, with each claim standing on its own as defining separately claimed subject matter.

The above-disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents and shall not be restricted or limited by the foregoing detailed description.

We claim:

1. A method for implementing an orchestration of continuous integration and continuous deployment (CI-CD), the method being implemented by at least one processor, the method comprising:
receiving, by the at least one processor, a set of data from at least one user via a user interface (UI) to allow access to a developer utility platform;
receiving, by the at least one processor, a request from the at least one user to access project data associated with at least one software product;
fetching, by the at least one processor, the project data from at least one database, in response to the request received from the at least one user;
displaying, by the at least one processor, a plurality of options related to the project data, to the at least one user;
creating, by the at least one processor, at least one pull request upon receiving an input that relates to the plurality of options from the at least one user;
generating, by the at least one processor, the at least one pull request in case of an absence of a reception of a code freeze request; and
implementing, by the at least one processor, a deployment of a change in a code into a target branch from a source branch based on the generated at least one pull request.

2. The method as claimed in claim 1, wherein the plurality of options comprises a selection of at least one from among a team, a repository, the source branch, the target branch, an employee identity (ID) of a reviewer, a request to view the at least one pull request, a request to delete the at least one pull request, a request to clean at least one outdated branch, the code freeze request, and a deployment freeze request.

3. The method as claimed in claim 2, wherein the request to delete the at least one pull request corresponds to a removal of at least one from among outdated pull requests and unwanted pull requests.

4. The method as claimed in claim 1, wherein the input received from the at least one user is received as one from among a text-based input and a command-based input, wherein the input is received in a sequential manner.

5. The method as claimed in claim 1, wherein the project data comprises a project name, a project date, a number of users working on a project, and information related to teams working on the project.

6. The method as claimed in claim 1, wherein the set of data comprises login credentials and registration details that are usable for accessing the developer utility platform.

7. The method as claimed in claim 1, wherein the deployment of the change in the code corresponds to a merging of the code from the source branch to the target branch.

8. The method as claimed in claim 1, wherein the method further comprises displaying, by the at least one processor to the at least one user, a pull request uniform resource locator (URL) for the generated at least one pull request.

9. A computing device configured to implement an orchestration of continuous integration and continuous deployment (CI-CD), the computing device comprising:
a processor;
a memory; and
a communication interface coupled to each of the processor and the memory, wherein the processor is configured to:
receive, from at least one user via the communication interface and a user interface (UI), a set of data to allow access to a developer utility platform;
receive, from the at least one user via the communication interface, a request to access a project data associated with at least one software product;
fetch the project data from at least one database, in response to the request received from the at least one user;
display a plurality of options related to the project data, to the at least one user;
create at least one pull request upon reception of an input from the at least one user that relates to the plurality of options;
generate the at least one pull request in case of an absence of a reception of a code freeze request; and
implement a deployment of a change in a code into a target branch from a source branch based on the generated at least one pull request.

10. The computing device as claimed in claim 9, wherein the plurality of options comprises a selection of at least one from among a team, a repository, the source branch, the target branch, an employee identity (ID) of a reviewer, a request to view the at least one pull request, a request to delete the at least one pull request, a request to clean at least one outdated branch, the code freeze request, and a deployment freeze request.

11. The computing device as claimed in claim 10, wherein the request to delete the at least one pull request corresponds to a removal of at least one from among outdated pull requests and unwanted pull requests.

12. The computing device as claimed in claim 9, wherein the input received from the at least one user is received as one from among a text-based input and a command-based input, wherein the input is received in a sequential manner.

13. The computing device as claimed in claim 9, wherein the project data comprises a project name, a project date, a number of users working on a project, and information related to teams working on the project.

14. The computing device as claimed in claim 9, wherein the set of data comprises login credentials of the at least one user and registration details that are usable for accessing the developer utility platform.

15. The computing device as claimed in claim 9, wherein the deployment of the change in the code corresponds to a merging of the code from the source branch to the target branch.

16. The computing device as claimed in claim 9, wherein the processor is further configured to display, to the at least one user, a pull request uniform resource locator (URL) for the generated at least one pull request.

17. A non-transitory computer readable storage medium storing instructions for implementing an orchestration of continuous integration and continuous deployment (CI-CD), the storage medium comprising executable code which, when executed by a processor, causes the processor to:
receive a set of data from at least one user, via a user interface (UI), to allow access to a developer utility platform;
receive a request from the at least one user to access project data associated with at least one software product;
fetch the project data from at least one database, in response to the request received from the at least one user;
display a plurality of options related to the project data, to the at least one user;
create at least one pull request upon reception of an input that relates to the plurality of options from the at least one user;
generate the at least one pull request in case of an absence of a reception of a code freeze request; and
implement a deployment of a change in a code into a target branch from a source branch based on the generated at least one pull request.

18. The storage medium as claimed in claim 17, wherein the plurality of options comprises a selection of at least one from among a team, a repository, the source branch, the target branch, an employee identity (ID) of a reviewer, a request to view the at least one pull request, a request to delete the at least one pull request, a request to clean at least one outdated branch, the code freeze request, and a deployment freeze request.

19. The storage medium as claimed in claim 18, wherein the request to delete the at least one pull request corresponds to a removal of at least one from among outdated pull requests and unwanted pull requests.

20. The storage medium as claimed in claim 17, wherein the deployment of the change in the code corresponds to a merging of the code from the source branch to the target branch.
